(19) United States
(12) Patent Application Publication
(10) Pub. No.: US 2007/0238001 A1
(43) Pub. Date: Oct. 11, 2007

(54) CARBON SUPPORT FOR FUEL CELL, ELECTRODE MATERIAL FOR FUEL CELL, MEMBRANE ELECTRODE ASSEMBLY USING THE SAME, FUEL CELL, FUEL CELL POWER SYSTEM, AND ELETRONIC EQUIPMENT

(76) Inventor: TORU KOYAMA, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/733,219

(22) Filed: Apr. 10, 2007

(30) Foreign Application Priority Data
Apr. 10, 2006 (JP) 2006-107256

(51) Int. Cl. H01M 8/10; H01B 1/04

(52) U.S. Cl. 429/33; 252/502

(57) ABSTRACT

It is an object of the present invention to allow a membrane electrode assembly for fuel cell to stably work for extended periods. A highly electron-conductive carbon supporting a catalyst is incorporated with a proton-conductivity providing group, e.g., sulfonic acid group or sulfoalkyl group, and hydrogen peroxide decomposing group, e.g., phosphonic acid group or phosphoalkyl group.

### FIELD OF THE INVENTION

The present invention relates to a carbon support for fuel cell, an electrode material for fuel cell, a membrane electrode assembly and fuel cell using the same, a fuel cell power system, and an electronic equipment.

### BACKGROUND OF THE INVENTION

Polymer electrolyte fuel cells have been under development for commercialization as power sources for vehicles, distributed cogeneration systems and mobile devices because of their advantages of high output density, operability at low temperature and environmental harmony. As is well known, a polymer electrolyte fuel cell comprises a membrane electrode assembly (MEA) having a polymer electrolyte membrane held between an anode and cathode, supplied with a respective fuel and oxidant (e.g., air or oxygen) to generate power by electrochemical reactions between these reaction gases. The fuels useful for the fuel cell include hydrogen, methanol, dimethyl ether, ethylene glycol, and hydrazine as reductants.

A conventional electrode layer is produced by spreading and drying a pasty mixture of carbon and polymer electrolyte, the former supporting fine catalyst particles. It is composed of aggregates in which carbon particles of 10 to 50 nm in diameter agglomerate with each other to have pores (primary pores) of several tens nanometers in diameter and these aggregates agglomerate with each other to form gaps (secondary pores) of several hundreds nanometers in diameter. The molecules of a polymer electrolyte, having a diameter of several tens nanometers, cannot penetrate into the primary pores (Non-patent Document 1), by which is meant that a catalyst in the primary pores is not coated with the polymer electrolyte to have little contribution to the electrochemical reactions in the cell. As a result, the catalyst has a low utilization factor, normally 10 to 30% or so. Methods have been proposed to provide catalyst-supporting carbon in the primary pores with proton conductivity, in order to utilize the catalyst more effectively (Patent Documents 1 and 2).

Patent Document 1 discloses a method in which sulfonic acid group or the like is directly bound to catalyst-supporting carbon in the primary pores with fuming sulfuric acid or the like to allow the proton migrate in the primary pores even in the absence of a polymer electrolyte.

On the other hand, Patent Document 2 incorporates a proton-conductor precursor, e.g., proton-conductive monomer, in catalyst-supporting carbon in the primary pores, and binds the precursor to each other or polymerizes the precursor to produce a proton-conductive substance, e.g., proton-conductive polymer.

Patent Document 1: JP-A 2004-79420

Patent Document 2: WO 04/17446

Non-patent Document 1: J. of Electrochem. Soc., 142, 4143 (1995)

### BRIEF SUMMARY OF THE INVENTION

An MEA is normally produced by preparing a pasty mixture of catalyst-supporting carbon, polymer electrolyte and solvent, and spreading the paste on each side of a polymer electrolyte membrane and drying the resulting film of the paste to form an electrode. The electrode layer has a structure with carbon black whose primary particles are 10 to 50 nm in diameter and beaded, where these particles support fine catalyst particles of Pt or Pt/Ru having a diameter of 1 to 6 nm. The carbon-supported catalyst is coated with the polymer electrolyte.

The electrochemical reaction proceeding on each electrode is described with oxygen as an oxidant and hydrogen as a reductant.
On anode: H₂→2H⁺+2e⁻ (1)
On cathode: ½O₂+2H⁺+2e⁻→H₂O (2)
Total reactions: H₂+½O₂→H₂O (3)

As illustrated, hydrogen is oxidized on a catalyst on the anode to produce electron and proton. The proton migrates through a polymer electrolyte in the electrode and polymer electrolyte membrane towards the cathode, and the electron migrates through carbon to be collected, and migrate through an external circuit towards the cathode. Therefore, the reaction on each electrode proceeds only on the polymer electrolyte which can simultaneously give and receive an active material gas (hydrogen or oxygen), proton (H+) and electron (e−) and on the fine catalyst particle surfaces in contact with the polymer electrolyte and carbon (three-phase interface).

The proton conductive material precursor is not a polymer but monomer and can penetrate into the primary pores because of its smaller molecular size. The methods disclosed by Patent Documents 1 and 2 are effective, because the catalyst uncoated with the polymer electrolyte can also contribute to the cell reaction to improve catalyst utilization factor and output density and reduce catalyst requirement. However, these methods involve problems that the fuel cell incorporated with the catalyst-supporting carbon deteriorates in characteristics while in service for extended periods.

It is an object of the present invention to improve stability of a fuel cell for extended periods.

The present invention provides a carbon support for fuel cell, with a proton-conductivity providing group and hydrogen peroxide decomposing group introduced on the surface; electrode material, membrane electrode assembly using the same; fuel cell; fuel cell power system; and electronic equipment.

Other objects, features and advantages of the invention will become apparent from the following description of the embodiments of the invention taken in conjunction with the accompanying drawings.

### BRIEF DESCRIPTION OF THE DRAWINGS

FIG. 1 is a cross-sectional view outlining structure of the membrane electrode assembly prepared as one embodiment of the present invention.

FIG. 2 schematically illustrates concept of carbon support of the present invention used in an electrode.

FIG. 3 is a cross-sectional view illustrating structure of a unit fuel cell for a direct methanol fuel cell power system of the present invention.

FIG. 4 is a developed oblique view illustrating structure of a unit fuel cell for a polymer electrolyte fuel cell power system as one embodiment of the present invention.

FIG. 5 presents load current-output voltage, output density characteristics observed in Example and Comparative Example.

FIG. 6 presents load current-output voltage, output density characteristics observed in other Example and Comparative Example.

FIG. 7 presents load current-output voltage, output density characteristics observed in still other Example and Comparative Example.

FIG. 8 is a developed oblique view illustrating a major portion of a hydrogen-oxygen fuel cell prepared as one embodiment of the present invention.

FIG. 9 is a block diagram of a fuel cell power system which includes a fuel cell having a membrane electrode assembly as one embodiment of the present invention.

FIG. 10 is a cross-sectional view of a portable information terminal which includes a fuel cell having a membrane electrode assembly of the present invention.

### DESCRIPTION OF REFERENCE NUMERALS

1: Polymer electrolyte membrane, 2: Anode, 3: Cathode, 4: Secondary particle pores, 5: Primary carbon particles, 6: Polymer electrolyte, 7: Secondary carbon particles, 8: Anode-side diffusion layer, 9: Cathode-side diffusion layer, 10: Anode-side current collector, 11: Cathode-side current collector, 12: Fuel, 13: Air, 14: Anode-side terminal, 15: Cathode-side terminal, 16: Anode-side terminal plate, 17: Cathode-side terminal plate, 18: Gasket, 19: O-ring, 20: Bolt/nut, 24: Anode-side diffusion layer, 25: Cathode-side diffusion layer, 26: Fuel passage provided in a separator, 27: Air passage provided in a separator, 28: Hydrogen+water, 29: Hydrogen, 30: Water, 31: Air, 32: Air+water, 40: Proton-conductivity providing group, 45: Hinge equipped with a fuel cartridge, 46: Slits, 47: Display, 48: Main board, 49: Antenna, 50: Hinge equipped with a cartridge holder, 51: Main board, 52: Lithium-ion secondary battery, 53: Air filter, 54: Water-absorbing, quick-drying material, 55: Case, 60: Water-repellent surfactant membrane, 90: Catalyst particles, 100: Hydrogen peroxide decomposing group, 133: Cathode-side terminal plate, 134: Cathode-side current collector, 135: Supporter for MEA provided with diffusion layer, 136: Packing, 137: Anode-side terminal, 138: Fuel tank, 139: Anode-side terminal plate, 140: Electric double layer capacitor, 141: DC/DC converter, 142: Judgment/controlling device, 143: Load blocking switch, 144: Fuel cell

### DETAILED DESCRIPTION OF THE INVENTION

The inventors of the present invention have extensively studied behavior of carbon with proton conductivity exhibited in a fuel cell to provide a carbon support for fuel cell, with a proton-conductivity providing group and a hydrogen peroxide decomposing group introduced on the surface; an electrode material; a membrane electrode assembly using the same; a fuel cell; a fuel cell power system, and an electronic equipment.

The inventors of the present invention have found that a fuel, oxygen or the like tends to be deficient in primary pores to produce hydrogen peroxide, which can possibly oxidize cell components with which it is in contact and deteriorate their serviceability, achieving the present invention. More specifically, carbon in primary pores, when provided with a proton-conductive group and hydrogen peroxide decomposing group, e.g., phosphonic acid group or the like, is serviceable for extended periods, because these group works to prevent oxidation of the carbon. The treating agent for providing the carbon support surfaces with these functional groups is preferably of a monomer or low-molecular-weight compound, otherwise it cannot penetrate into the support pores to sufficiently introduce these groups in the pores.

The hydrogen peroxide decomposing group decomposes hydrogen peroxide formed on electrode and in the pores by the electrochemical reactions proceeding in the fuel cell, thereby deterioration of cell components which are in contact with hydrogen peroxide. The functional group may be referred to as an oxidation resistance providing group in a sense that it can improve oxidation resistance of cell components which are in contact with hydrogen peroxide.

The carbon support is incorporated with a monomer or precursor for a polymer electrolyte on the surface and in the pores, after being provided with the proton-conductive group and hydrogen peroxide decomposing group, to form reaction fields. It is highly preferable to use a monomer or precursor for a polymer electrolyte for the present invention. Transmission electron microscopic analysis of an electrode layer of conventional fuel cell indicates that a catalyst in the pores is not coated with a polymer electrolyte and hence has little contribution to the cell reactions, because it is used in the form of electrolyte polymer. By contrast, use of a monomer or precursor for a polymer electrolyte allows the resulting polymer to efficiently penetrate into the pores, when a carbon electrode catalyst is mixed with the polymer electrolyte, to form the three-phase interface. The interface can be more securely formed when the carbon support for cathode is treated with a water-repellent surfactant or the like.

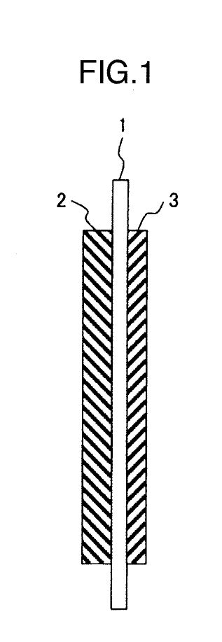

Next, some of the embodiments of the present invention are described in detail by referring to the attached drawings. FIG. 1 is a cross-sectional view illustrating a structure of membrane electrode assembly to which the present invention is applied, wherein the electrolyte membrane 1 is held between the anode 2 and cathode 3, on which hydrogen, methanol or the like as a fuel reacts and oxidant gas, e.g., air, reacts, respectively.

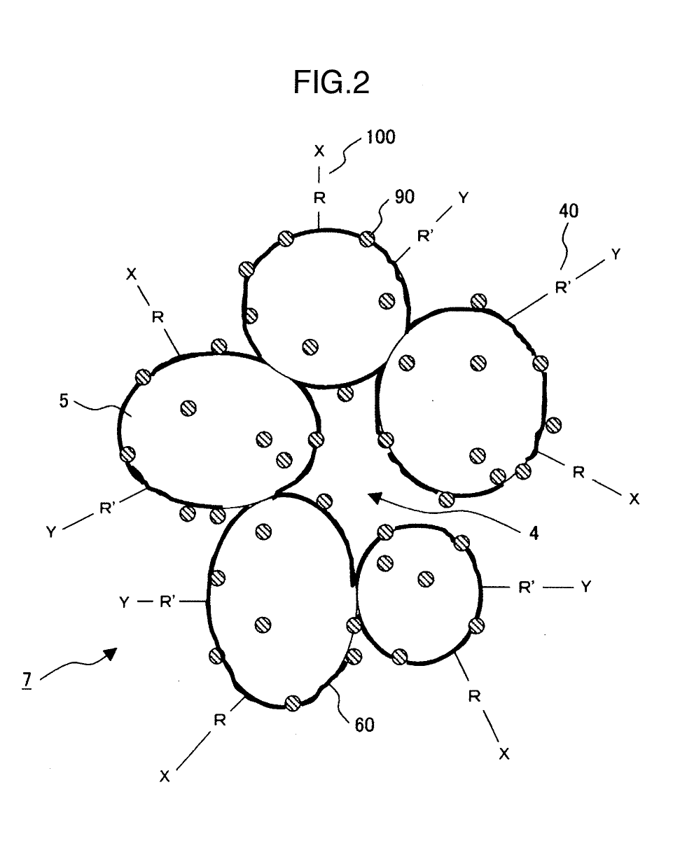

FIG. 2 schematically illustrates a structure of carbon support as one embodiment of the present invention used for forming fuel cell electrode, where the primary carbon particles 5 support the finely dispersed metallic catalyst particles 90, e.g., noble metal particles. The carbon particles have the proton-conductivity providing group 40 and hydrogen peroxide decomposing group 100 bound to the surfaces directly or via an adequate organic group R or R′, e.g., OH—CH₂—. These functional groups are also formed on the surfaces or in the pores of the secondary carbon particles 7, although not shown.

Of the carbon supports of the present invention, that for cathode is preferably treated with a water-repellent surfactant to form the water-repellent surfactant membrane 60 on the carbon particle surfaces and in the secondary pores 4. FIG. 2 illustrates the cathode-side carbon support. On the other hand, a water-repellent film is not necessary for the anode-side carbon support, and is rather harmful.

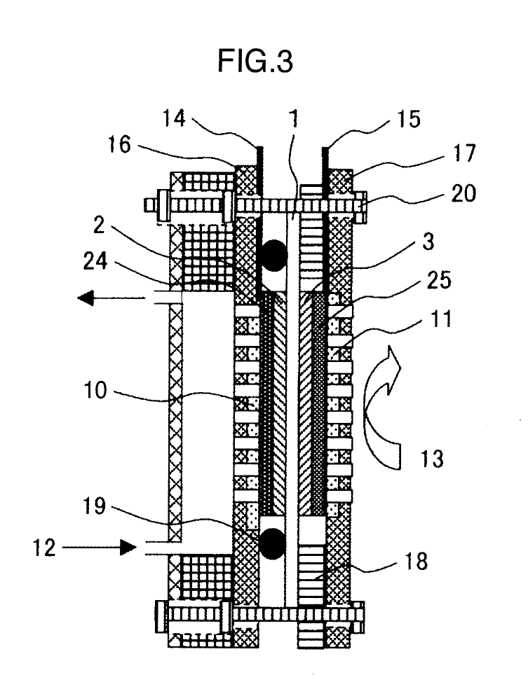

These carbon supports are used to form a membrane electrode assembly illustrated in FIG. 1. It is coated with the anode-side diffusion layer 24 and anode-side current collector 10 on the anode side, and cathode-side diffusion layer 25 and cathode-side current collector 11 on the cathode side. It is provided with the anode-side terminal 14 and cathode-side terminal 15, held between the anode-side terminal plate 16 and cathode-side terminal plate 17, and secured as a whole by the bolts/nuts 20 to prepare a unit fuel cell for a fuel cell power system, illustrated in FIG. 3. The unit cell illustrated in FIG. 3 is a passive methanol fuel cell, where the fuel 12 circulates around a fuel chamber, and the cathode-side terminal plate 17 is provided with a window to bring the air 13 into direct contact with the cathode-side diffusion layer 25.

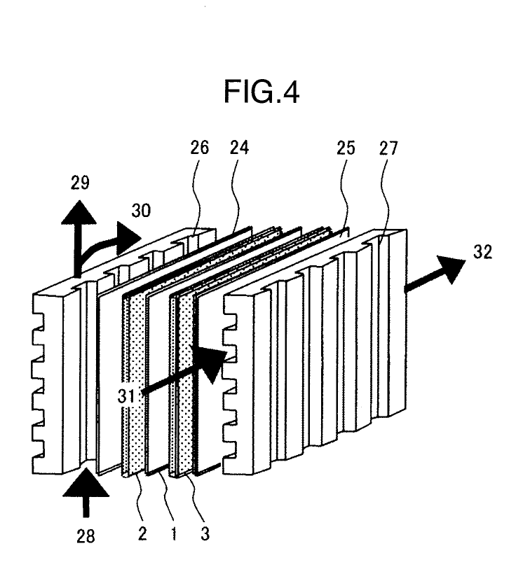

FIG. 4 is a developed oblique view illustrating a method for structuring a power system comprising a desired number of the unit fuel cells illustrated in FIG. 3 to have an objective power generation capacity. The power system illustrated in FIG. 4 is described in more detail later.

The catalyst support for the present invention is not limited, so long as it is of electron-conductive carbon. Some examples of the support materials include furnace black, channel black, acetylene black, amorphous carbon, carbon nano-tubes, carbon nano-horns, activated carbon and graphite. They may be used either individually or in combination. Of these, carbon black is more preferable in consideration of the primary pore structure and secondary agglomerated structure. The group for providing carbon with proton conductivity is not limited, so long as it is proton-conductive and causes no interruption of movement of fuel, oxygen or the like in the primary pores. More specifically, these groups include sulfonic acid group and sulfoalkyl group.

Carbon can be provided with proton conductivity by one of the following methods.

(1) Treatment with sulfuric acid gas, fuming sulfuric acid, sulfuric acid or the like to introduce sulfonic acid group.

(2) Treatment with sodium sulfite, sodium bisulfite, aqueous formalin solution, paraformaldehyde or the like to introduce sulfomethyl group.

(3) Halogenoalkylation, followed by acetylthiolation and oxidation to introduce a sulfoalkyl group, or treatment with a sultone to directly introduce a sulfoalkyl group.

A proton-conductive group can be directly incorporated in carbon, or in catalyst-supporting carbon, the latter being more preferable in consideration of reduced characteristic fluctuations. It is incorporated preferably at 0.4 to 1.8 mill-equivalents per gram of dry carbon.

The hydrogen peroxide decomposing group (group which provides carbon with hydrogen peroxide decomposing capability) is not limited, so long as it accelerates decomposition of hydrogen peroxide and causes no interruption of movement of fuel, oxygen or the like in the primary pores. More specifically, these groups useful for the present invention include phosphonic acid and phosphoalkyl groups. One of the methods for providing carbon with hydrogen peroxide decomposing capability introduces chloromethyl group which is hydrolyzed with phosphonic acid triethyl ether. The group is incorporated at 0.2 to 0.6 mill-equivalents per gram of dry carbon, particularly preferably 0.3 to 0.4 mill-equivalents/g.

The cathode (support) is preferably treated to be water-repellent to remove water produced by the electrochemical reactions and prevent flooding by the water. The water-repellent agents useful for the present invention include fluorocarbon, polytetrafluoroethylene, tetrafluoroethylene-perfluoroalkyl vinyl ether copolymer and tetrafluoroethylene-hexafluoropropylene copolymer.

The catalyst for the present invention may be of any metal so long as it oxidizes a fuel, e.g., hydrogen, methanol, dimethyl ether, ethylene glycol or hydrazine, and reduces oxygen. These metals include platinum (Pt), gold, silver, palladium, iridium, rhodium, ruthenium (Ru), iron, cobalt, nickel, chromium, tungsten, manganese, vanadium and an alloy thereof, of which Pt, platinum/ruthenium (Pt/Ru), in particular, are more widely used.

The catalyst metal normally has a particle diameter of 10 to 300 angstroms. The catalyst is preferably bound to a support, e.g., carbon or the like, to reduce its usage. It is incorporated at 0.01 to 10 mg/cm² of the electrode after it is formed. Thickness of the catalyst layer is not limited, but preferably 10 to 100 μm, particularly preferably 10 to 50 μm. It is preferably thicker than 10 μm in consideration of durability, and thinner than 50 μm in consideration of catalyst efficiency. The anode catalyst layer is preferably thicker than the cathode catalyst layer, because the reaction (1) with an aqueous solution of fuel, e.g., methanol, proceeds more slowly on the anode.

The anode catalyst layer is preferably 10 to 200 μm thick, particularly preferably 50 to 150 μm thick. The cathode catalyst layer is preferably 1 to 50 μm thick, particularly preferably 5 to 20 μm thick. The anode catalyst layer and anode-side diffusion layer are preferably hydrophilicization-treated to be more wettable with an aqueous fuel solution, e.g., methanol. On the other hand, the cathode-side diffusion layer is preferably hydrophobicization-treated for improved water-repellency to prevent accumulation of water produced by the electrochemical reactions.

The polymer electrolyte membrane for the present invention is not limited so long as it is proton-conductive. More specifically, it may be of a fluorine-base solid polymer represented by polyperfluorosulfonic acid known as trade names of Nafion® (Du Pont), Aciplex® (ASAHI KASEI) and Flemion® (ASAHI KASEI).

Another preferable membrane material is a sulfonic acid type polystyrene-graft-ethylene tetrafluoroethylene (ETFE) copolymer having a main chain produced by copolymerization of fluorine-carbide-base vinyl monomer and hydrocarbon-base vinyl monomer, and hydrocarbon-base side chain having sulfonic acid group, as disclosed by JP-A-9-102322.

JP-A-9-102322 also discloses a polymer electrolyte membrane of sulfonic acid type polystyrene-graft-ETFE, and U.S. Pat. No. 4,012,303 and U.S. Pat. No. 4,605,685 disclose a partially fluorinated polymer electrolyte membrane in which a membrane produced by copolymerization of fluorine-carbide-base vinyl monomer and hydrocarbon-base vinyl monomer is graft-polymerized with α,β,β-trifluorostyrene and then incorporated with sulfonic acid group.

JP-A-6-93114 discloses a polymer electrolyte membrane of sulfonated polyetheretherketone; JP-A-9-245818 and JP-A-11-116679 disclose a polymer electrolyte membrane of sulfonated polyether sulfone; JP-A-10-503788 discloses a polymer electrolyte membrane of sulfonated acrylonitrile/butadiene/styrene polymer. JP-A-11-510198 discloses a polymer electrolyte membrane of sulfonated polysulfide, and JP-A-11-515040 discloses a polymer electrolyte membrane of sulfonated engineering plastic, e.g., sulfonated polyphenylene.

JP-A-2002-110174 discloses polymer electrolyte membranes of polyetheretherketone, polyethersulfone, polyetherethersulfone, polysulfone, polysulfide and polyphenylene, all sulfoalkylated.

JP-A-2003-100317 discloses a polymer electrolyte membrane of sulfoalkylated engineering plastic, e.g., sulfoalkylated polyetherethersulfone, and JP-A-2003-187826 discloses a polymer electrolyte membrane of aromatic hydrocarbon, e.g., sulfoalkylated polyphenylene.

Of these polymer electrolyte membranes, those of aromatic hydrocarbon are more preferable viewed from fuel permeability. An aromatic hydrocarbon incorporated with an alkylene sulfonic acid group is more preferable for fuel cells for mobile devices, viewed from methanol permeability, swelling resistance and durability.

A composite electrolyte membrane with a heat resistant resin finely dispersed with a proton-conductive inorganic compound can make the fuel cell operable at a higher temperature. These inorganic compounds include hydrated tungsten oxide, hydrated zirconium oxide, hydrated tin oxide, silicotungstic acid, silicomolybdic acid, tungstophosphoric acid and molybdophosphoric acid.

An acidic electrolyte membrane containing a hydrate is generally deformed when swollen, and may not have a sufficient mechanical strength when it is highly ion-conductive. In such a case, it is effective to reinforce the membrane, while it is produced, with a filler to improve cell reliability. One example of such a filler contains, as a core, a non-woven or woven fabric of fibers of high mechanical strength, durability and heat resistance.

The electrolyte membrane may be of a polybenzimidazole doped with sulfuric acid, phosphoric acid, sulfonic acid or phosphonic acid to reduce fuel permeability.

The polymer electrolyte membrane preferably contains sulfonic acid at 0.5 to 2.5 milliequivalents/g-dry resin, particularly preferably 0.8 to 1.8 milliequivalents/g-dry resin. The content beyond the above range is not desirable, because the membrane may have an excessive ion conduction resistance at a lower content, and tends to be dissolved in water at a higher content.

Thickness of the polymer electrolyte membrane is not limited, but preferably 10 to 200 μm, particularly preferably 30 to 100 μm. The membrane is preferably thicker than 10 μm to have a practical strength, and thinner than 200 μm to have reduced membrane resistance, or improved power generation efficiency. When solution casting is adopted, membrane thickness can be controlled by solution concentration or thickness of solution film spread on a substrate. When the membrane is produced from molten state, its thickness can be controlled by drawing a film of given thickness, prepared by melt pressing, extrudation or the like, at a desired draw ratio.

The polymer electrolyte membrane for the present invention is not limited so long as it is proton-conductive, with carbon particles supporting an anode catalyst or cathode catalyst being bonded to each other thereon. It may be of a fluorine-base solid polymer represented by polyperfluorosulfonic acid known as trade names of Nafion® (Du Pont), Aciplex® (ASAHI KASEI) and Flemion® (ASAHI KASEI).

JP-A-2003-100317 discloses a polymer electrolyte membrane of sulfoalkylated engineering plastic, e.g., sulfoalkylated polyetherethersulfone, and JP-A-2003-187826 discloses a polymer electrolyte membrane of aromatic hydrocarbon, e.g., sulfoalkylated polyphenylene. Of these polymer electrolytes, those having high oxidation resistance are more preferable.

The polymer electrolyte membrane preferably contains sulfonic acid at 0.5 to 2.5 milliequivalents/g-dry resin, particularly preferably 0.8 to 1.8 milliequivalents/g-dry resin. The polymer electrolyte preferably contains sulfonic acid at a higher content than the membrane thereof viewed from ion conductivity. The membrane may be incorporated with one or more additives normally used for high-molecular-weight compounds, e.g., plasticizer, oxidation inhibitor, hydrogen peroxide decomposing agent, metal scavenger, surfactant, stabilizer, releasing agent or the like within limits not harmful to the object of the present invention.

The oxidation inhibitors useful for the present invention include amine-base ones, e.g., phenol-α-naphthylamine, phenol-β-naphthylamine, diphenylamine, p-hydroxydiphenylamine and phenothiazine; and phenol-base ones, e.g., 2,6-di(t-butyl)-p-cresol, 2,6-di(t-butyl)-p-phenol, 2,4-dimethyl-6-(t-butyl)-p-phenol, p-hydroxyphenylcyclohexane, di-p-hydroxyphenylcyclohexane, styrenated phenol and 1,1′-methylenebis(4-hydroxy-3,5-t-butylphenol).

The other oxidation inhibitors include sulfur-base ones, e.g., dodecylmercaptan, dilaurylthiodipropionate, distearylthiodipropionate, dilauryl sulfide and mercaptobenzimidazole; and phosphorus-based ones, e.g., trinonylphenyl phosphite, trioctadecyl phosphite, tridecyl phosphate and trilauryltrithiophosphite.

The hydrogen peroxide decomposing agent for the present invention is not limited, so long as it has a catalytic function for decomposing hydrogen peroxide. For example, the agents useful for the present invention include metals, metal oxides, metal phosphates, metal fluorides and macrocyclic metal complexes, in addition to the oxidation inhibitors described above. They may be used either individually or in combination. The suitable metals include Ru and Ag; metal oxides include RuO, WO₃, CeO₂ and Fe₃O₄; metal phosphates include CePO₄, CrPO₄, AlPO₄ and FePO₄; metal fluorides include CeF₃ and FeF₃; and macrocyclic metal complexes include Fe-porphyrin, Co-porphyrin, heme and catalase. In particular, it is recommended to use Ru₂O or CePO₄ for its high hydrogen peroxide decomposing capability.

The metal scavenger for the present invention is not limited, so long as it reacts with a metallic ion, e.g., Fe⁺⁺ or Cu⁺⁺, to pacify the metal and suppress a deterioration-accelerating effect of the ion by forming a complex with the ion. The metal scavengers useful for the present invention include crown ethers, e.g., tenoyltrifluoroacetone, sodium diethylthiocarbamate (DDTC), 1,5-diphenyl-3-thiocarbazone, 1,4,7,10,13-pentaoxycyclopentadecane, and 1,4,7,10,13,16-hexaoxycyclopentadecane; and cryptands, e.g., 4,7,13,16-tetraoxa-1,10-diazacyclooctadecane and 4,7,13,16,21,24-hexaoxy-1,10-diazacyclohexacosane. Moreover, porpohyrin-base compounds, e.g., tetraphenylporphyrin, may be also used. Content of the scavenger is not limited to those described in Examples.

Of these scavengers, a combination of phenol-base oxidation inhibitor and phosphorus-base oxidation inhibitor, in particular, is preferable because it brings the effect in a small quantity and has limited adverse effects on various fuel cell characteristics. These oxidation inhibitor, hydrogen peroxide decomposing agent and metal scavenger may be incorporated in an electrolyte membrane, electrode or membrane/electrode interface. In particular, incorporation of these additives in a cathode or cathode/membrane interface is preferable because it brings the effect in a small quantity and has limited adverse effects on various fuel cell characteristics.

The method for bonding an electrolyte membrane to an electrode for forming a fuel cell is not limited, and may be selected from known ones. For example, an MEA may be produced by spreading a mixture of Pt catalyst powder supported by an electroconductive material (e.g., carbon) and polytetrafluoroethylene suspension on a carbon sheet and heat-treated to form a catalyst layer.

Then, an electrolyte solution containing the same electrolyte as that for the membrane or fluorine-base electrolyte may be spread as a binder on the catalyst layer, and integrated with the electrolyte membrane by hot pressing. Moreover, an MEA may be produced by a method selected from the following:

(1) A Pt catalyst powder is coated beforehand with an electrolyte solution containing the same electrolyte as that for the electrolyte membrane.

(2) A catalyst paste is spread on the electrolyte membrane by spraying, slit spraying or ink jetting.

(3) The electrolyte membrane is electrolessly plated with an electrode.

(4) A metal complex ion of platinum group is adsorbed on the electrolyte membrane and then reduced.

Of these methods, the method of spreading a catalyst paste on the electrolyte membrane by ink jetting is more advantageous because of smaller loss of catalyst.

### EXAMPLES

The present invention is described in more detail by Examples, which by no means limit the scope of the present invention.

### Examples 1 to 4

(1) Introduction of Phosphonic Acid Group in Carbon Black

In these examples, 10 g of carbon black supporting a Pt/Ru catalyst of fine equiatomic Pt/Ru alloy powder dispersed to 50% by mass was incorporated with anhydrous aluminum chloride (AlCl₃), and then with thiophosphate chloride (PSCl₃) slowly while keeping temperature at 35° C. or lower. Quantities of those incorporated are given in Table 1. The resulting mixture was kept at 70 to 75° C. for 45 minutes. It was then incorporated with 50 mL of chloroform after it was cooled, and filtered. The separated carbon black was then sufficiently washed with diethyl ether, incorporated with 200 mL of ion-exchanged water, and treated under reflux for 20 hours. The phosphonic acid group was present at 0.4 to 1.1 milliequivalents/g-dry carbon support, as given in Table 1.

Similarly, 10 g of carbon black supporting 30% by mass of fine platinum powder was incorporated with anhydrous aluminum chloride (AlCl₃), and then with thiophosphate chloride (PSCl₃) slowly while keeping temperature at 35° C. or lower. Quantities of those incorporated are given in Table 1.

The resulting mixture was kept at 70 to 75° C. for 45 minutes. It was then incorporated with 50 mL of chloroform after it was cooled, and filtered. The separated carbon black was then sufficiently washed with diethyl ether, incorporated with 200 mL of ion-exchanged water, and treated under reflux for 20 hours. The phosphonic acid group was present at 0.4 to 1.1 milliequivalents/g-dry carbon support, as given in Table 1.

(2) Introduction of Sulfonic Acid Group in Carbon Black

Next, 100 g of the carbon black supporting the Pt/Ru catalyst, prepared in the section (1) above, was heated at 105° C. for 1 hour, and was then incorporated with sulfur trioxide gas heated at 80 to 110° C. (its concentration relative to dry air is given in Table 1), with which it was reacted for a time given in Table 1. The reaction effluent was cooled, and the carbon black supporting the Pt/Ru catalyst was thrown into ion-exchanged water, stirred, filtered and washed with ion-exchanged water until the filtrate had a constant pH level. The Fourier-transformed infrared absorption spectral pattern of the resulting carbon black supporting the Pt/Ru catalyst showed absorption peaks at 1225, 1037 and 620 cm−1 due to —SO₃H group, which were not observed with the sample before it was treated with sulfur trioxide gas, by which it was confirmed that —SO₃H group was introduced in the carbon black surface. The sulfonic acid group was present at 1.2 to 1.8 milliequivalents/g-dry carbon support in the carbon black with phosphonic and sulfonic acid groups, as given in Table 1.

Next, 100 g of the carbon black supporting the fine Pt powder, prepared in the step (1) above, was heated at 105° C. for 1 hour, and was then incorporated with sulfur trioxide gas heated at 80 to 110° C. (its concentration relative to dry air is given in Table 1), with which it was reacted for a time given in Table 1. The reaction effluent was cooled, and the carbon black supporting the Pt catalyst was thrown into ion-exchanged water, stirred, filtered and washed with ion-exchanged water until the filtrate had a constant pH level.

The Fourier-transformed infrared absorption spectral pattern of the resulting carbon black supporting the Pt catalyst showed absorption peaks at 1225, 1037 and 620 cm−1 due to —SO₃H group, which were not observed with the sample before it was treated with sulfur trioxide gas, by which it was confirmed that —SO₃H group was introduced in the carbon black surface. The sulfonic acid group was present in the carbon black with phosphonic and sulfonic acid groups at 1.2 to 1.8 milliequivalents/g-dry carbon support, as given in Table 1.

(3) Synthesis of Chloromethylated Polyether Sulfone

A 500 mL four-mouthed, round-bottom flask equipped with a reflux condenser, to which a stirrer, thermometer and calcium chloride tube were connected, was charged with 30 g of polyether sulfone (PES) and 250 mL of tetrachloroethane, after it was purged with nitrogen. Then, it was further charged with 40 mL of chloromethylmethyl ether and then with a mixed solution of 1 mL of anhydrous tin chloride (IV) and 20 mL of tetrachloroethane dropwise. The resulting mixture was heated at 80° C. for 90 minutes with stirring. The reaction effluent solution was thrown into 1 L of methanol to precipitate a polymer. The precipitate was crushed by a mixer and washed with methanol to prepare chloromethylated polyether sulfone.
Formula (1)

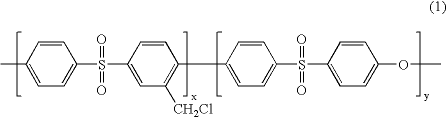

The chloromethyl group introduction rate, defined by the ratio of the structural unit into which chloromethyl group was introduced to the total structural units in the formula (1) (total of x and y), was 36%, as determined by the nuclear magnetic resonance spectroscopy.

(4) Synthesis of Acetylthioated Polyether Sulfone

A 1000 mL four-mouthed, round-bottom flask equipped with a reflux condenser, to which a stirrer, thermometer and calcium chloride tube were connected, was charged with 600 mL of N-methylppyrrolidone, and then with 50 mL of an N-methylppyrrolidone solution dissolving 9 g of potassium thioacetate. The resulting mixture was heated at 80° C. for 3 hours with stirring. The reaction effluent solution was thrown into 1 L of water to precipitate a polymer. The precipitate was crushed by a mixer and washed with water to prepare 32 g of acetylthioated polyether sulfone.

(5) Synthesis of Sulfomethylated Polyether Sulfone

A 500 mL four-mouthed, round-bottom flask equipped with a reflux condenser, to which a stirrer, thermometer and calcium chloride tube were connected, was charged with 20 g of the acetylthioated polyether sulfone prepared in the step (4), and then with 300 mL of acetic acid and 20 mL of hydrogen peroxide solution. The resulting mixture was heated at 45° C. for 4 hours with stirring.

The resulting reaction effluent solution was incorporated in 1 L of a 6 N aqueous solution of sodium hydroxide while the mixture was cooled and stirred for a while. The resulting polymer was separated by filtration, and washed with water until the alkaline component was eliminated. Then, it was incorporated in 300 mL of 1 N hydrochloric acid solution and stirred for a while. The polymer was separated by filtration, washed with water until the acid component was eliminated and dried under a vacuum to quantitatively prepare 20 g of sulfomethylated polyether sulfone. The presence of sulfomethyl group was confirmed by NMR analysis, which showed the chemical shift of methylene proton was shifted to 3.78 ppm. The sulfomethyl group introduction rate, defined by the ratio of the structural unit into which sulfomethyl group was introduced to the total structural units in the formula (2) (total of x and y), was 36%, on the basis of introduction rate of chloromethyl group.
Formula (2) 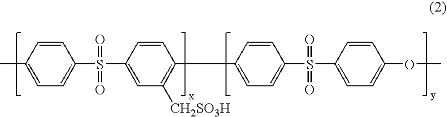
(6) Preparation of Polymer Electrolyte Membrane

The sulfomethylated polyether sulfone, prepared in the step (5), was dissolved in a 50/50 mixed solvent of dimethylacetoamide and methoxy ethanol to have a concentration of 5% by mass, and the resulting solution was developed on a glass plate by spin coating, dried by wind, and dried at 80° C. under a vacuum to prepare a 42 μm thick electrolyte membrane of sulfomethylated polyether sulfone. It had a methanol permeability of 12 mA/cm² and ion conductivity of 0.053 S/cm at room temperature.

(7) Preparation of Membrane Electrode Assembly (MEA)

Sulfomethylated polyether sulfone was prepared by the procedures similar to those adopted in the steps (3) to (6) to have a sulfomethyl group introduction rate of 41%, defined by the ratio of the structural unit into which sulfomethyl group was introduced to the total structural units in the formula (2) (total of x and y). It was used to prepare the polymer electrolyte in the anode.

The carbon supporting the Pt/Ru catalyst, incorporated with phosphonic and sulfonic acid groups (prepared in the step (2) above), was slurried with a mixed solvent of 1-propanol, 2-propanol and methoxy ethanol dissolving the above-described polymer electrolyte at 30% by mass. The slurry was spread on a polyimide film by screen printing to prepare the anode, about 125 μm thick, 30 mm wide and 30 mm long.

Then, the sulfonated carbon supporting the Pt catalyst, incorporated with phosphonic and sulfonic acid groups (prepared in the step (2) above), was slurried with a mixed solvent of water and alcohol, where a solution of polyperfluorosulfonic acid dissolved in mixed solvent of 1-propanol, 2-propanol and methoxy ethanol was used as a binder. The slurry was spread on a polyimide film by screen printing to prepare the cathode, about 20 μm thick, 30 mm wide and 30 mm long. About 0.5 mL of a mixed solvent of 1-propanol, 2-propanol and methoxy ethanol dissolving the polymer electrolyte at 5% by mass was penetrated into the anode surface. The surface-treated anode was bonded to the electrolyte membrane of sulfomethylated polyether sulfone, prepared in the step (6), under a load of about 1 kg, and the resulting assembly was dried at 80° C. for 3 hours.

Next, about 0.5 mL of a mixed solvent of 1-propanol, 2-propanol and methoxy ethanol dissolving the polymer electrolyte at 5% by mass was penetrated into the cathode surface. The surface-treated cathode was bonded to the polymer electrolyte membrane to overlap the anode layer across the membrane under a load of about 1 kg, and the resulting assembly was dried at 80° C. for 3 hours to prepare the MEA (a).

A carbon powder was incorporated with an aqueous dispersion of fine polytetrafluoroethylene (PTFE) particles as a water repellent (Dispersion D-1, DAIKIN INDUSTRIES) to prepare a paste containing the PTFE at 40% by mass after it was calcined. The paste was spread on one side of carbon cloth (thickness: about 350 μm and void fraction: 87%). It was dried at room temperature and then calcined at 270° C. for 3 hours to form the carbon sheet, where the PTFE content was set at 5 to 20% by mass based on the carbon cloth. The sheet was cut to have the same size as the electrode in the MEA to prepare the cathode-side diffusion layer.

Carbon cloth (thickness: about 350 μm and void fraction: 87%) was immersed in 1 mol % sulfuric acid held in a flask, and kept at 60° C. for 2 days in a flow of nitrogen. Then, the flask content was cooled to room temperature, and the sulfuric acid was removed. The carbon cloth was sufficiently washed with distilled water until the used water became neutral.

It was immersed in methanol and then dried. It had absorption peaks at 1225 and 1413 cm−1 due to —OSO₃H group and at 1049 cm−1 due to —OH group in the infrared spectral pattern, by which it was confirmed that —OSO₃H and —OH groups were introduced in the cloth surface. It was hydrophilic, having a contact angle with an aqueous methanol solution smaller than that (81°) of carbon cloth not treated with sulfuric acid. Moreover, it was highly electroconductive. It was cut to have the same size as the electrode in the MEA (a) to prepare the anode-side diffusion layer.

(8) Power Generation Capacity of Fuel Cell (DMFC)

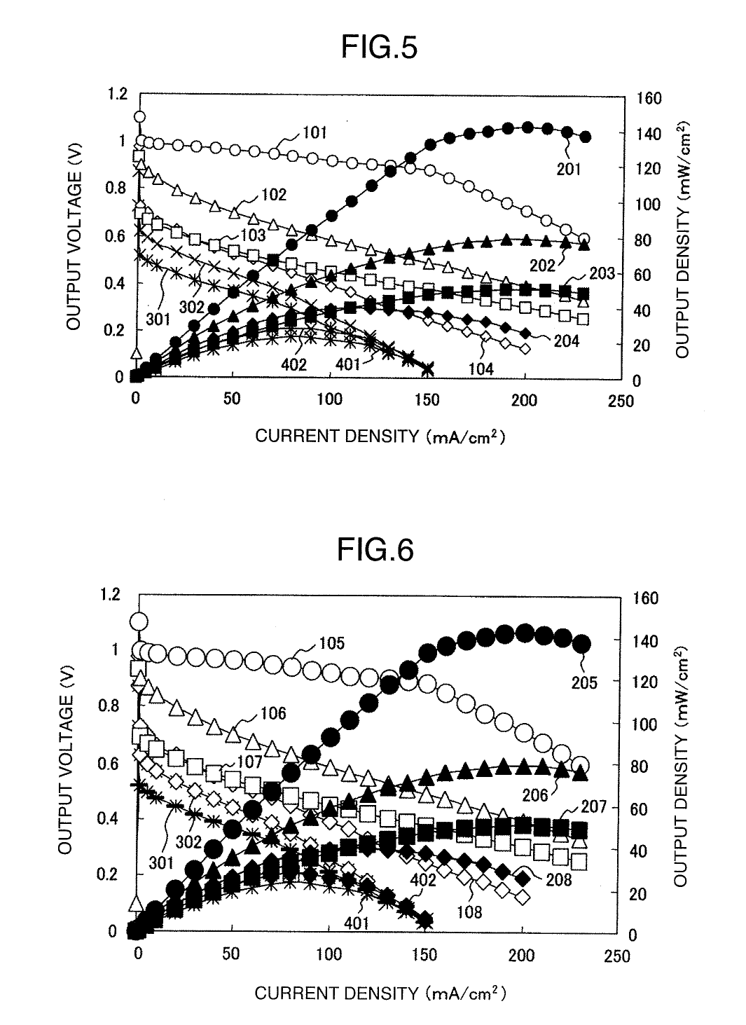

Power generation capacity of the polymer electrolyte unit fuel cell was measured, after it was incorporated with the MEA (a), as illustrated in FIG. 3, wherein 1: polymer electrolyte membrane, 2: anode, 3: cathode, 24: anode-side diffusion layer, 25: cathode-side diffusion layer, 40: anode-side current collector, 41: cathode-side current collector, 12: fuel, 13: air, 14: anode-side terminal, 15: cathode-side terminal, 16: anode-side terminal plate, 17: cathode-side terminal plate, 18: gasket, 19: O-ring, and 20: bolt/nut. A 20% by mass aqueous methanol solution was circulated as the fuel 12 around the anode, and the air 13 was supplied to the cathode by natural breathing. FIG. 5 illustrates dependence of output voltage and output power density on current density.

FIGS. 5 to 7 are graphs illustrating the load current-output voltage characteristics and output voltage characteristics of the fuel cells prepared in Examples and Comparative Examples, wherein 101: output voltage of the cell prepared in Example 1, 102: output voltage of the cell prepared in Example 2, 103: output voltage of the cell prepared in Example 3, 104: output voltage of the cell prepared in Example 4, 105: output voltage of the cell prepared in Example 5, 106: output voltage of the cell prepared in Example 6, and 107: output voltage of the cell prepared in Example 7.

To continue, 108: output voltage of the cell prepared in Example 8, 109: output voltage of the cell prepared in Example 9, 110: output voltage of the cell prepared in Example 10, 111: output voltage of the cell prepared in Example 11, 112: output voltage of the cell prepared in Example 12, 201: output density of the cell prepared in Example 1, 202: output density of the cell prepared in Example 2, 202: output density of the cell prepared in Example 1, 203: output density of the cell prepared in Example 3, 204: output density of the cell prepared in Example 4, 205: output density of the cell prepared in Example 5, 206: output density of the cell prepared in Example 6, 207: output density of the cell prepared in Example 7, 208: output density observed in Example 8, 209: output density observed in Example 9, 210: output density of the cell prepared in Example 10, 211: output density of the cell prepared in Example 11, 212: output density of the cell prepared in Example 12, 401: output density of the cell prepared in Comparative Example 1, 402: output density of the cell prepared in Comparative Example 2, 301: output voltage of the cell prepared in Comparative Example 1, 302: output voltage of the cell prepared in Comparative Example 2, 303: output voltage of the cell prepared in Comparative Example 3, 401: output density of the cell prepared in Comparative Example 1, and 402: output density of the cell prepared in Comparative Example 2.

In FIG. 5, 101: data representing dependence of output voltage on current density, observed in Example 1, 102: data representing dependence of output voltage on current density, observed in Example 2, 103: data representing dependence of output voltage on current density, observed in Example 3, 104: data representing dependence of output voltage on current density, observed in Example 4, 201: data representing dependence of output density on current density, observed in Example 1, 202: data representing dependence of output density on current density, observed in Example 2, 203: data representing dependence of output density on current density, observed in Example 3, and 204: data representing dependence of output density on current density, observed in Example 4. Table 1 gives output voltage of each cell working for 4000 hours at a current density of 50 mA/cm².

TABLE 1

| | | Examples | | | | Comparative Examples | | |
|---|---|---|---|---|---|---|---|---|
| | | 1 | 2 | 3 | 4 | 1 | 2 | 3 |
| Carbon | Anhydrous aluminum | 15 | 10 | 7 | 5 | — | Content of | — |
| supporting | chloride (g) | | | | | | sulfomethyl | |
| Pt/Ru | Thiophosphate chloride | 54 | 36 | 25 | 18 | — | group | — |
| | (ml) | | | | | | introduced: | |
| | Phosphonic acid content | 1.1 | 0.7 | 0.55 | 0.4 | 0 | 0.6 meq/g | 0 |
| | (meq/g) | | | | | | | |
| | Sulfur trioxide gas | 12 | 10 | 8 | 6 | — | | 12 |
| | concentration | | | | | | | |
| | (% by volume) | | | | | | | |
| | Reaction time (hours) | 2 | 2 | 3 | 4 | — | | 2 |
| | Sulfonic acid group | 1.8 | 1.5 | 1.3 | 1.2 | 0 | | 1.8 |
| | content (meq/g) | | | | | | | |
| Carbon | Anhydrous aluminum | 15 | 10 | 7 | 5 | — | Content of | — |
| supporting | chloride (g) | | | | | | sulfomethyl | |
| Pt | Thiophosphate chloride | 54 | 36 | 25 | 18 | — | group | — |
| | (ml) | | | | | | introduced: | |
| | Phosphonic acid content | 1.1 | 0.7 | 0.55 | 0.4 | 0 | 0.6 meq/g | 0 |
| | (meq/g) | | | | | | | |
| | Sulfur trioxide gas | 12 | 10 | 8 | 6 | — | | 12 |
| | concentration | | | | | | | |
| | (% by volume) | | | | | | | |
| | Reaction time (hours) | 2 | 2 | 3 | 4 | — | | 2 |
| | Sulfonic acid group | 1.8 | 1.5 | 1.3 | 1.2 | 0 | | 1.8 |
| | content (meq/g) | | | | | | | |

| | | | | | | | |
|---|---|---|---|---|---|---|---|
| Output voltage (V at 50 mA/cm²) | 0.97 | 0.7 | 0.54 | 0.52 | 0.36 | 0.44 | 0.95 |
| Maximum output density (mW/cm²) | 142 | 79 | 51 | 40 | 23 | 28 | 135 |
| Output voltage (V) of cell after | 0.96 | 0.68 | 0.53 | 0.5 | 0 | 0 | 0 |
| working for 4000 hours at a current | | | | | | | |
| density of 50 mA/cm² | | | | | | | |

As illustrated in Table 1, the unit fuel cell prepared in each of Examples is highly durable, because it keeps an output voltage substantially equivalent to the initial level for 4000 hours. It is also noted, as illustrated in Table 1 and FIG. 5, that output voltage and maximum output density increase at a low current density of 50 mA/cm² as sulfonization extent increases. In a passive type fuel cell equipped with no auxiliary machine, e.g., pump or blower for forcibly supplying air to the cathode, in particular, more water is produced on the cathode as current density increases. Therefore, it may fail to smoothly generate power because of blocked supply of air (oxygen) by the accumulated water. Increased output at a low current density is highly desirable, and the cell prepared in each of Examples is particularly suitable for such a fuel cell of high output.

### Comparative Example 1

(1) Preparation of Membrane Electrode Assembly (MEA)

Carbon black (not sulfonation-treated) supporting a Pt/Ru catalyst, composed of fine equiatomic Pt/Ru alloy powder dispersed to 50% by mass, was prepared. It was slurried with a mixed water/alcohol solvent (water/isopropanol/normal propanol: 20/40/40 by mass) with a 30% by mass polyperfluorosulfonic acid electrolyte as a binder. The slurry was spread on a polyimide film by screen printing to prepare the anode, about 125 μm thick, 30 mm wide and 30 mm long.

Next, carbon (not sulfonation-treated) supporting a fine Pt powder dispersed to 30% by mass was slurried with a mixed water/alcohol solvent with a 30% by mass polyperfluorosulfonic acid as a binder. The slurry was spread on a polyimide film by screen printing to prepare the cathode, about 20 μm thick, 30 mm wide and 30 mm long. About 0.5 mL of a 5% by mass alcoholic aqueous solution of polyperfluorosulfonic acid (solvent: 20/40/40 by mass mixture of water/isopropanol/normal propanol) was penetrated into the anode surface. The surface-treated anode was bonded to the electrolyte membrane of sulfomethylated polyether sulfone, prepared in the step (5) in Example 1, under a load of about 1 kg, and the resulting assembly was dried at 80° C. for 3 hours. Next, about 0.5 mL of a mixed solvent of 1-propanol, 2-propanol and methoxy ethanol containing the polymer electrolyte at 5% by mass was penetrated into the cathode surface. The surface-treated cathode was bonded to the polymer electrolyte membrane to overlap the anode layer across the membrane under a load of about 1 kg, and the resulting assembly was dried at 80° C. for 3 hours to prepare the MEA (b).

The hydrophilicized carbon cloth and hydrophobicized carbon cloth, both prepared in Example 1, were used as the anode-side and cathode-side diffusion layers, respectively.

(2) Power Generation Capacity of Fuel Cell (DMFC)

Power generation capacity of the polymer electrolyte unit fuel cell was measured, after it was incorporated with the MEA (b), as illustrated in FIG. 3, wherein a 20% by mass aqueous methanol solution was circulated as a fuel around the anode, and air was supplied to the cathode by natural breathing. FIG. 5 illustrates dependence of output voltage and output power density on current density, wherein 301: data representing dependence of output voltage on current density, observed in Comparative Example 1, 401: data representing dependence of output density on current density, observed in Comparative Example 1. Table 1 gives output voltage and maximum output density at a current density of 50 mA/cm², and output voltage of the cell working for 4000 hours at a current density of 50 mA/cm².

As shown in Table 1, the cell has improved output voltage and durability, when its carbon support is incorporated with the proton conductivity providing group and oxidation resistance providing group.

### Comparative Example 2

(1) Introduction of Methylene Sulfonic Acid Group into Carbon Black

A 500 mL four-mouthed, round-bottom flask equipped with a reflux condenser, to which a stirrer, thermometer and calcium chloride tube were connected, was charged with 100.0 g of the carbon black supporting the Pt/Ru catalyst, 17.5 g (0.14 mols) of sodium sulfite, 12.5 g (0.12 mols) of sodium bisulfite, 50 g of a 37% by mass aqueous formalin solution (0.62 mols) and 30.0 g of para-formaldehyde (1.00 mol as formaldehyde) in a flow of nitrogen, after it was purged with nitrogen. The resulting mixture was heated at 85° C. for 1 hour and then at 90° C. for 15 hours.

The effluent was filtered, and the separated carbon black supporting the Pt/Ru catalyst was immersed in a 1 N aqueous sulfuric acid solution to protonize Na⁺ and then sufficiently washed with ion-exchanged water. The resulting carbon black supporting the Pt/Ru catalyst and untreated carbon black supporting the Pt/Ru catalyst were analyzed by Fourier-transformed infrared absorption spectroscopy. The spectral pattern of the former carbon black showed absorption peaks at 620 and 1037 cm−1 due to stretching vibration of SO₂ and symmetric stretching vibration of SO₂, which were not observed with the latter carbon. These peaks are considered to be due to methylene sulfonic acid group introduced into the carbon black supporting the Pt/Ru catalyst.

The carbon black supporting the Pt/Ru catalyst, treated with sulfonic acid, was analyzed by elementary analysis to determine atomic sulfur content and thereby determine sulfonic acid group content. The sulfonic acid group was present in the carbon black at 1.8 milliequivalents/g-dry carbon support.

A 500 mL four-mouthed, round-bottom flask equipped with a reflux condenser, to which a stirrer, thermometer and calcium chloride tube were connected, was charged with 100.0 g of the carbon black supporting the Pt catalyst, 17.5 g (0.14 mols) of sodium sulfite, 12.5 g (0.12 mols) of sodium bisulfite, 50 g of a 37% by mass aqueous formalin solution (0.62 mols) and 30.0 g of para-formaldehyde (1.00 mol as formaldehyde) in a flow of nitrogen, after it was purged with nitrogen. The resulting mixture was heated at 85° C. for 1 hour and then at 90° C. for 15 hours. The effluent was filtered, and the separated carbon black supporting the Pt catalyst was immersed in a 1 N aqueous sulfuric acid solution to protonize Na⁺ and then sufficiently washed with ion-exchanged water.

The resulting carbon black supporting the Pt catalyst and untreated carbon black supporting the Pt catalyst were analyzed by Fourier-transformed infrared absorption spectroscopy. The spectral pattern of the former carbon black showed absorption peaks at 620 and 1037 cm−1 due to stretching vibration of SO₂ and symmetric stretching vibration of SO₂, which were not observed with the latter carbon. These peaks are considered to be due to methylene sulfonic acid group introduced into the carbon black supporting the Pt catalyst. The carbon black supporting the Pt catalyst, treated with sulfonic acid, was analyzed by elementary analysis to determine atomic sulfur content and thereby determine sulfonic acid group content. The sulfonic acid group was present in the carbon black at 1.8 milliequivalents/g-dry carbon support.

(2) Preparation of Membrane Electrode Assembly (MEA)

An MEA (MEA (c)) was prepared in the same manner as in Example 1, except that the sulfonated carbon supporting the catalyst was replaced by the carbon supporting the catalyst, prepared in the step (1) above to have methylene sulfonic acid group.

(3) Power Generation Capacity of Fuel Cell (DMFC)

Power generation capacity of the polymer electrolyte unit fuel cell was measured, after it was incorporated with the MEA (c), as illustrated in FIG. 4, wherein a 20% by mass aqueous methanol solution was circulated as a fuel around the anode, and air was supplied to the cathode. FIG. 5 illustrates dependence of output voltage and output power density on current density, wherein 302: data representing dependence of output voltage on current density, observed in Comparative Example 2 and 402: data representing dependence of output density on current density, observed in Comparative Example 2. Table 1 gives output voltage and maximum output density at a current density of 50 mA/cm², and output voltage of the cell working for 4000 hours at a current density of 50 mA/cm².

As shown in Table 1, the cell has improved output voltage and durability, when its carbon support is incorporated with the proton conductivity providing group and oxidation resistance providing group.

### Comparative Example 3

(1) Introduction of Sulfonic Acid Group by Sulfur Trioxide Gas in Carbon Black

Next, 100 g of the carbon black supporting a Pt/Ru catalyst of fine equiatomic Pt/Ru alloy powder dispersed to 50% by mass was heated at 105° C. for 1 hour, and was then incorporated with sulfur trioxide gas heated at 80 to 110° C. (its concentration relative to dry air is given in Table 1), with which it was reacted for a time given in Table 1. The reaction effluent was cooled, and the carbon black supporting the Pt/Ru catalyst was thrown into ion-exchanged water, stirred, filtered and washed with ion-exchanged water until the filtrate had a constant pH level.

The Fourier-transformed infrared absorption spectral pattern of the resulting carbon black supporting the Pt/Ru catalyst showed absorption peaks at 1225, 1037 and 620 cm−1 due to —SO₃H group, which were not observed with the sample before it was treated with sulfur trioxide gas, by which it was confirmed that —SO₃H group was introduced in the carbon black surface. Table 1 gives sulfonic acid group content of the sulfonated carbon black.

Similarly, 100 g of the carbon black supporting 30% by mass of catalyst of fine platinum powder was heated at 105° C. for 1 hour, and was then incorporated with sulfur trioxide gas heated at 80 to 110° C. (its concentration relative to dry air is given in Table 1), with which it was reacted for a time given in Table 1. The reaction effluent was cooled, and the carbon black supporting the Pt catalyst was thrown into ion-exchanged water, stirred, filtered and washed with ion-exchanged water until the filtrate had a constant pH level.

The Fourier-transformed infrared absorption spectral pattern of the resulting carbon black supporting the Pt catalyst showed absorption peaks at 1225, 1037 and 620 cm−1 due to —SO₃H group, which were not observed with the sample before it was treated with sulfur trioxide gas, by which it was confirmed that —SO₃H group was introduced in the carbon black surface. Table 1 gives sulfonic acid group content of the sulfonated carbon black.

(2) Preparation of Membrane Electrode Assembly (MEA)

An MEA (MEA (d)) was prepared in the same manner as in Example 1, except that the sulfonated carbon supporting the catalyst was replaced by the carbon supporting the catalyst, prepared in the step (1) above to have methylene sulfonic acid group.

(3) Power Generation Capacity of Fuel Cell (DMFC)

Power generation capacity of the polymer electrolyte unit fuel cell was measured, after it was incorporated with the MEA (d), as illustrated in FIG. 4, wherein a 20% by mass aqueous methanol solution was circulated as a fuel around the anode, and air was supplied to the cathode. Table 1 gives output voltage and maximum output density at a current density of 50 mA/cm², and output voltage of the cell working for 4000 hours at a current density of 50 mA/cm².

As shown in Table 1, the cell has improved output voltage and durability, when its carbon support is incorporated with the proton conductivity providing group and oxidation resistance providing group.

### Examples 5 to 8

(1) Introduction of Phosphonic Acid Group in Carbon Black

In these examples, 50 g of the carbon black supporting the Pt/Ru catalyst of fine equiatomic Pt/Ru alloy powder dispersed to 50% by mass was incorporated with 268 g of phosphorus trichloride (PCl₃) and 60 g of anhydrous aluminum chloride (AlCl₃), and treated under reflux for 6 hours. Then, the reaction effluent was incorporated with 500 mL of ion-exchanged water, after an excessive quantity of phosphorus trichloride was distilled off. It was filtered and the separated carbon black was sufficiently washed with ion-exchanged water. It was then incorporated with a 2 N aqueous solution of sodium hydroxide and kept at 90° C. for 2 hours. It was filtered, and the separated carbon black was sufficiently washed with a 4 N aqueous hydrochloric acid solution and then with ion-exchanged water. It was then incorporated with a 2 N aqueous nitric acid solution and kept at 95° C. for 2 hours. It was then cooled, filtered and washed with water. The phosphonic acid group was present at 0.5 to 1.0 milliequivalents/g-dry carbon support, as given in Table 2.

TABLE 2

| | | Examples | | | | Comparative Examples | | |
|---|---|---|---|---|---|---|---|---|
| | | 5 | 6 | 7 | 8 | 1 | 2 | 3 |
| Carbon | Anhydrous aluminum | 90 | 67 | 60 | 45 | — | Content of | — |
| supporting | chloride (g) | | | | | | sulfomethyl | |
| Pt/Ru | Phosphorus trichloride (g) | 400 | 300 | 268 | 200 | — | group | — |
| | Phosphonic acid group content | 1 | 0.8 | 0.7 | 0.5 | 0 | introduced: | 0 |
| | (meq/g) | | | | | | 0.6 meq/g | |
| | Sulfur trioxide gas | 12 | 10 | 8 | 6 | — | | 12 |
| | concentration | | | | | | | |
| | (% by volume) | | | | | | | |
| | Reaction time (hours) | 2 | 2 | 3 | 4 | — | | 2 |
| | Sulfonic acid group content | 1.8 | 1.5 | 1.3 | 1.2 | 0 | | 1.8 |
| | (meq/g) | | | | | | | |
| Carbon | Anhydrous aluminum | 90 | 67 | 60 | 45 | — | Content of | — |
| supporting | chloride (g) | | | | | | sulfomethyl | |
| Pt | Phosphorus trichloride (g) | 400 | 300 | 268 | 200 | — | group | — |
| | Phosphonic acid group content | 1 | 0.8 | 0.7 | 0.5 | 0 | introduced: | 0 |
| | (meq/g) | | | | | | 0.6 meq/g | |
| | Sulfur trioxide gas | 12 | 10 | 8 | 6 | — | | 12 |
| | concentration | | | | | | | |
| | (% by volume) | | | | | | | |
| | Reaction time (hours) | 2 | 2 | 3 | 4 | — | | 2 |
| | Sulfonic acid group content | 1.8 | 1.5 | 1.3 | 1.2 | 0 | | 1.8 |
| | (meq/g) | | | | | | | |

| | | | | | | | |
|---|---|---|---|---|---|---|---|
| Output voltage (V at 50 mA/cm²) | 0.98 | 0.7 | 0.54 | 0.52 | 0.36 | 0.44 | 0.95 |
| Maximum output density (mW/cm²) | 145 | 79 | 51 | 40 | 23 | 28 | 135 |
| Output voltage (V) of cell after working | 0.97 | 0.68 | 0.53 | 0.51 | 0 | 0 | 0 |
| for 4000 hours at a current density of 50 | | | | | | | |
| mA/cm² | | | | | | | |

Similarly, 10 g of the carbon black supporting 30% by mass of the catalyst of fine platinum powder was incorporated with 268 g of phosphorus trichloride (PCl₃) and 60 g of anhydrous aluminum chloride (AlCl₃), and treated under reflux for 6 hours. Then, the reaction effluent was incorporated with 500 mL of ion-exchanged water, after an excessive quantity of phosphorus trichloride was distilled off. It was filtered and the separated carbon black was sufficiently washed with ion-exchanged water. It was then incorporated with a 2 N aqueous solution of sodium hydroxide and kept at 90° C. for 2 hours. It was filtered, and the separated carbon black was sufficiently washed with a 4 N aqueous hydrochloric acid solution and then with ion-exchanged water. It was then incorporated with a 2 N aqueous nitric acid solution and kept at 95° C. for 2 hours. It was then cooled, filtered and washed with water. The phosphonic acid group was present at 0.5 to 1.0 milliequivalents/g-dry carbon support, as given in Table 2.

(2) Introduction of Sulfonic Acid Group in Carbon Black

Next, 100 g of the carbon black supporting the Pt/Ru catalyst, prepared in the section (1) above, was heated at 105° C. for 1 hour, and was then incorporated with sulfur trioxide gas heated at 80 to 110° C. (its concentration relative to dry air is given in Table 1), with which it was reacted for a time given in Table 1. The reaction effluent was cooled, and the carbon black supporting the Pt/Ru catalyst was thrown into ion-exchanged water, stirred, filtered and washed with ion-exchanged water until the filtrate had a constant pH level. The Fourier-transformed infrared absorption spectral pattern of the resulting carbon black supporting the Pt/Ru catalyst showed absorption peaks at 1225, 1037 and 620 cm−1 due to —SO₃H group, which were not observed with the sample before it was treated with sulfur trioxide gas, by which it was confirmed that —SO₃H group was introduced in the carbon black surface.

The sulfonic acid group was present in the carbon black with phosphonic and sulfonic acid groups at 1.2 to 1.8 milliequivalents/g-dry carbon support, as given in Table 2.

Next, 100 g of the carbon black supporting the catalyst of fine Pt powder, prepared in the section (1) above, was heated at 105° C. for 1 hour, and was then incorporated with sulfur trioxide gas heated at 80 to 110° C. (its concentration relative to dry air is given in Table 1), with which it was reacted for a time given in Table 2. The reaction effluent was cooled, and the carbon black supporting the Pt catalyst was thrown into ion-exchanged water, stirred, filtered and washed with ion-exchanged water until the filtrate had a constant pH level.

The Fourier-transformed infrared absorption spectral pattern of the resulting carbon black supporting the Pt catalyst showed absorption peaks at 1225, 1037 and 620 cm−1 due to —SO₃H group, which were not observed with the sample before it was treated with sulfur trioxide gas, by which it was confirmed that —SO₃H group was introduced in the carbon black surface. The sulfonic acid group was present in the carbon black with phosphonic and sulfonic acid groups at 1.2 to 1.8 milliequivalents/g-dry carbon support, as given in Table 2.

(3) Preparation of Membrane Electrode Assembly (MEA)

An MEA (MEA (e)) was prepared in the same manner as in Example 1, except that the sulfonated carbon supporting the catalyst was replaced by the carbon supporting the catalyst, prepared in the step (1) above to have methylene sulfonic acid group.

(4) Power Generation Capacity of Fuel Cell (DMFC)

Power generation capacity of the polymer electrolyte unit fuel cell was measured, after it was incorporated with the MEA (e), as illustrated in FIG. 3, wherein 1: polymer electrolyte membrane, 2: anode, 3: cathode, 8: anode-side diffusion layer, 9: cathode-side diffusion layer, 40: anode-side current collector, 41: cathode-side current collector, 12: fuel, 13: air, 14: anode-side terminal, 15: cathode-side terminal, 16: anode-side terminal plate, 17: cathode-side terminal plate, 18: gasket, 19: O-ring, and 20: bolt/nut. A 20% by mass aqueous methanol solution was circulated as a fuel around the anode, and air 13 was supplied to the cathode by natural breathing. FIG. 5 illustrates dependence of output voltage and output power density on current density.

In FIG. 6, 105: data representing dependence of output voltage on current density, observed in Example 5, 106: data representing dependence of output voltage on current density, observed in Example 6, 107: data representing dependence of output voltage on current density, observed in Example 7, 108: data representing dependence of output voltage on current density, observed in Example 8, 205: data representing dependence of output density on current density, observed in Example 5, 206: data representing dependence of output density on current density, observed in Example 6, 207: data representing dependence of output density on current density, observed in Example 7, and 208: data representing dependence of output density on current density, observed in Example 8. Table 3 gives output voltage and maximum output density at a current density of 50 mA/cm², and output voltage of the cell working for 4000 hours at a current density of 50 mA/cm².

TABLE 3

| | | Examples | | | | Comparative Examples | | |
|---|---|---|---|---|---|---|---|---|
| | | 9 | 10 | 11 | 12 | 1 | 2 | 3 |
| Carbon | Chloromethylmethyl ether (mL) | 60 | 50 | 47 | 40 | — | — | Content of sulfone |
| supporting | Reaction time (hours) | 120 | 120 | 100 | 96 | — | — | acid group |
| Pt/Ru | Phosphomethyl group content | 0.4 | 0.4 | 0.35 | 0.3 | 0 | 0 | introduced: |
| | (meq/g) | | | | | | | 1.8 meq/g |
| | Sulfomethyl group content | 0.7 | 0.6 | 0.55 | 0.4 | 0 | 0.6 | |
| | (meq/g) | | | | | | | |
| Carbon | Chloromethylmethyl ether (mL) | 60 | 50 | 47 | 40 | — | — | Content of sulfone |
| supporting | Reaction time (hours) | 120 | 120 | 100 | 96 | — | — | acid group |
| Pt | Phosphomethyl group content | 0.4 | 0.4 | 0.35 | 0.3 | 0 | 0 | introduced: |
| | (meq/g) | | | | | | | 1.8 meq/g |
| | Sulfomethyl group content | 0.7 | 0.6 | 0.55 | 0.4 | 0 | 0.6 | |
| | (meq/g) | | | | | | | |

| | | | | | | | |
|---|---|---|---|---|---|---|---|
| Output voltage (V at 50 mA/cm²) | 0.97 | 0.86 | 0.63 | 0.48 | 0.36 | 0.44 | 0.95 |
| Maximum output density (mW/cm²) | 117 | 97 | 51 | 36 | 23 | 28 | 1.35 |
| Output voltage (V) of cell after working | 0.96 | 0.85 | 0.54 | 0.38 | 0 | 0 | 0 |
| for 4000 hours at a current density of | | | | | | | |
| 50 mA/cm² | | | | | | | |

Comparing the results of Examples 5 to 8 with those of Comparative Example 1, it is noted that the unit fuel cell with the electrodes of phosphonated and sulfonated carbon black supporting the catalyst shows a higher output voltage and maximum output density than the fuel cell with electrodes of conventional carbon black at a low current density of 50 mA/cm². It is also noted that the unit fuel cell of the present invention loses little output voltage even when it works for extended periods. Comparing the results of Examples 5 to 8 with those of Comparative Example 2, it is also noted that the unit fuel cell with the electrodes of phosphonated and sulfonated carbon black supporting the catalyst is more durable than the fuel cell with electrodes of conventional carbon black, because it is less dissolved in and swollen by methanol.

### Examples 9 to 12

(1) Introduction of Phosphomethyl Group in Carbon Black

A 500 mL four-mouthed, round-bottom flask equipped with a reflux condenser, to which a stirrer, thermometer and calcium chloride tube were connected, was charged, after it was purged with nitrogen, with 30 g of the carbon black supporting the Pt/Ru catalyst of fine equiatomic Pt/Ru alloy powder dispersed to 50% by mass, 250 mL of carbon disulfide, and further with chloromethylmethyl ether in a quantity given in Table 3, to which a mixed solvent of 1 mL of anhydrous tin chloride (IV) and 20 mL of carbon disulfide was added dropwise, and stirred under heating at 46° C. for a time given in Table 3.

Then, the reaction effluent solution was thrown into 1 L of methanol, and the resulting precipitate was crushed by a mixer and washed with ethanol to prepare chloromethylated carbon. The chloromethylated carbon was immersed in phosphoric acid triethyl ester, and heat-treated under reflux for 12 hours. The reaction effluent solution was thrown into 1 L of ethanol, and the resulting precipitate was crushed by a mixer and washed with ethanol to prepare chloromethyldiethylphosphomethylated carbon. The phosphomethyl group was present at 0.4 to 0.7 milliequivalents/g-dry resin, as given in Table 3.

(2) Introduction of Sulfomethyl Group in Carbon Black

A 1000 mL four-mouthed, round-bottom flask equipped with a reflux condenser, to which a stirrer, thermometer and calcium chloride tube were connected, was charged with 20 g of the chloromethydiethylphosphomethylated carbon, prepared above, to which 600 mL of N-methylpyrrolidone (NMR) was added. It was further charged with a solution of 9 g of potassium thioacetate dissolved in 50 mL of N-methylpyrrolidone (NMR). The reaction effluent solution was heated at 80° C. for 3 hours with stirring. Then, the reaction effluent solution was thrown into 1 L of water, and the resulting precipitate was crushed by a mixer and washed with water and dried under heating to prepare acetylthiodiethylphosphomethylated carbon.

A 500 mL four-mouthed, round-bottom flask equipped with a reflux condenser, to which a stirrer, thermometer and calcium chloride tube were connected, was charged with 20 g of the acetylthiodiethylphosphomethylated carbon, prepared above. It was further charged with 300 mL of acetic acid and then with 20 mL of hydrogen peroxide solution. The reaction effluent solution was heated at 45° C. for 4 hours with stirring.

The resulting reaction effluent solution was incorporated in 1 L of a 6 N aqueous solution of sodium hydroxide while it was cooled and stirred for a while. It was filtered, and the separated carbon black was washed with water until the acid component was eliminated and dried under a vacuum to quantitatively prepare 20 g of sulfomethydiethylphosphomethylated carbon. The sulfomethyl group was present at 0.3 to 0.4 milliequivalents/g-dry resin, as given in Table 3.

(3) Preparation of Membrane Electrode Assembly (MEA)

An MEA (MEA (f)) was prepared in the same manner as in Example 1, except that the sulfonated carbon supporting the catalyst was replaced by the carbon supporting the catalyst, prepared in the step (1) above to have methylsulfonic acid group.

(4) Power Generation Capacity of Fuel Cell (DMFC)

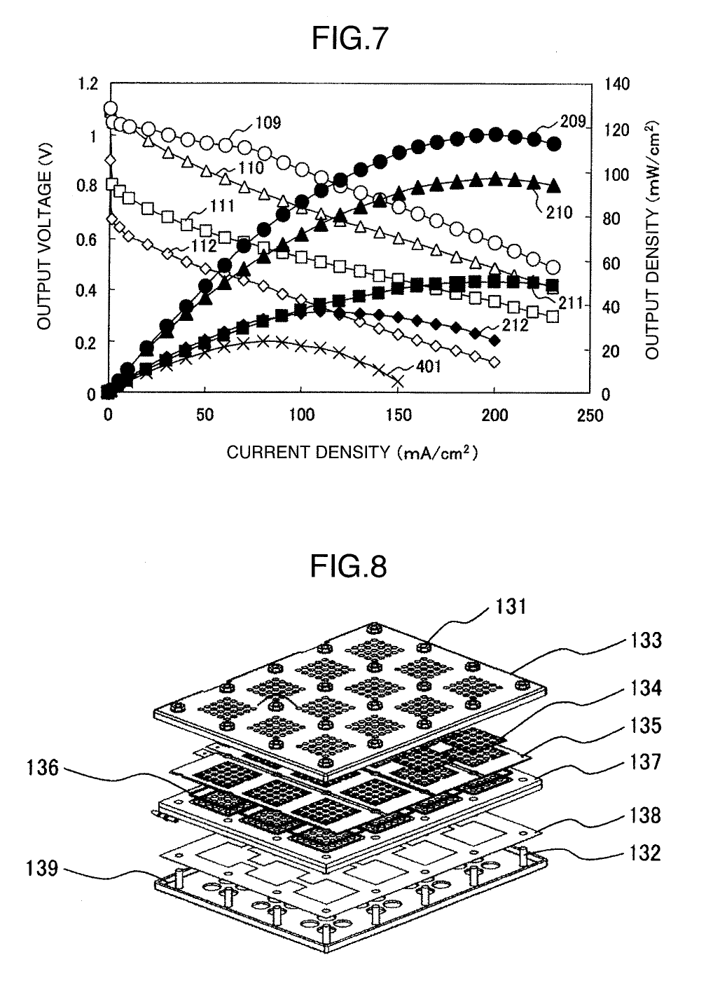

Power generation capacity of the polymer electrolyte unit fuel cell was measured, after it was incorporated with the MEA (f), as illustrated in FIG. 3, wherein a 20% by mass aqueous methanol solution was circulated as a fuel around the anode, and air was supplied to the cathode. FIG. 7 illustrates dependence of output voltage and output power density on current density. In FIG. 7, 109: data representing dependence of output voltage on current density, observed in Example 9, 110: data representing dependence of output voltage on current density, observed in Example 10, 111: data representing dependence of output voltage on current density, observed in Example 11, 112: data representing dependence of output voltage on current density, observed in Example 12, 113: data representing dependence of output voltage on current density, observed in Example 13, 209: data representing dependence of output density on current density, observed in Example 9, 210: data representing dependence of output density on current density, observed in Example 10, 211: data representing dependence of output density on current density, observed in Example 11, 212: data representing dependence of output density on current density, observed in Example 12, 301: data representing dependence of output voltage on current density, observed in Comparative Example 1, and 401: data representing dependence of output density on current density, observed in Comparative Example 1.

Table 3 gives output voltage and maximum output density of each cell at a current density of 50 mA/cm², and output voltage of the cell working for 4000 hours at a current density of 50 mA/cm².

Comparing the results of Examples 9 to 12 with those of Comparative Example 1, it is noted that the unit fuel cell with the electrodes of phosphonated and sulfonated carbon black supporting the catalyst shows a higher output voltage and maximum output density than the fuel cell with electrodes of conventional carbon black at a low current density of 50 mA/cm². It is also noted that the unit fuel cell of the present invention loses little output voltage even when it works for extended periods. Comparing the results of Examples 5 to 8 with those of Comparative Example 2, it is also noted that the unit fuel cell with the electrodes of phosphonated and sulfonated carbon black supporting the catalyst is more durable than the fuel cell with electrodes of conventional carbon black, because it is less dissolved in methanol.

### Example 13 and Comparative Example 4

In Example 13, a fuel cell power system fueled by hydrogen was assembled using a small-size unit fuel cell (polymer electrolyte fuel cell, PEFC) in which the MEA (a) prepared in Example 1 was included, as illustrated in FIG. 4, wherein 1: polymer electrolyte membrane, 2: anode, 3: cathode, 24: anode-side diffusion layer, 25: cathode-side diffusion layer, 26: electroconductive separator (bipolar plate) working to separate the electrode chambers from each other and, at the same time, providing a fuel gas supply passage, 27: electroconductive separator (bipolar plate) working to separate the electrode chambers from each other and, at the same time, providing an air supply passage, 28: hydrogen as a fuel and water, 29: hydrogen, 30: water, 31: air, and 32: air and water. Its cell capacity was measured. The small-size unit fuel cell was placed in a constant-temperature bath, controlled at a temperature to keep the separator inside, in which thermocouples (not shown) were placed, at 70° C. An external humidifier was provided for each of the anode and cathode, and its temperature is controlled at 70 to 73° C. to keep the dew point at 70° C. around the humidifier outlet. The dew point was measured by a dew point meter, and estimated from humidification water consumption, which was monitored on a steady basis, and flow rate, temperature and pressure of each reaction gas, to confirm that it was kept at a given level.

The PEFC in which the MEA (a) prepared in Example 1 was included was continuously operated for 10,000 hours under the conditions of hydrogen utilization factor: 70%, air utilization factor: 40% and current density: 50 mA/cm². It substantially kept an initial output voltage of 0.85 V for 10,000 hours. By contrast, a PEFC in which the MEA (d) prepared in Comparative Example 3 was included produced essentially no output in about 4,000 hours (Comparative Example 4). It is thus confirmed in Example 13 that the MEA of the present invention with the carbon support incorporated with the proton conductivity providing group and hydrogen peroxide decomposing group is serviceable for extended periods.

### Example 14

(1) Preparation of Fuel Cell

FIG. 8 illustrates one example of fuel cell 144 in which the MEA prepared in Example 1 is included, wherein 133: cathode-side terminal plate, 134: cathode-side current collector, 135: supporter for the membrane provided with diffusion layer) electrode assembly, 136: packing, 137: anode-side terminal plate, 138: fuel tank and 139: anode-side terminal plate, which were assembled in this order by bolts 132 and nuts 131.

(2) Preparation Fuel Cell Power System

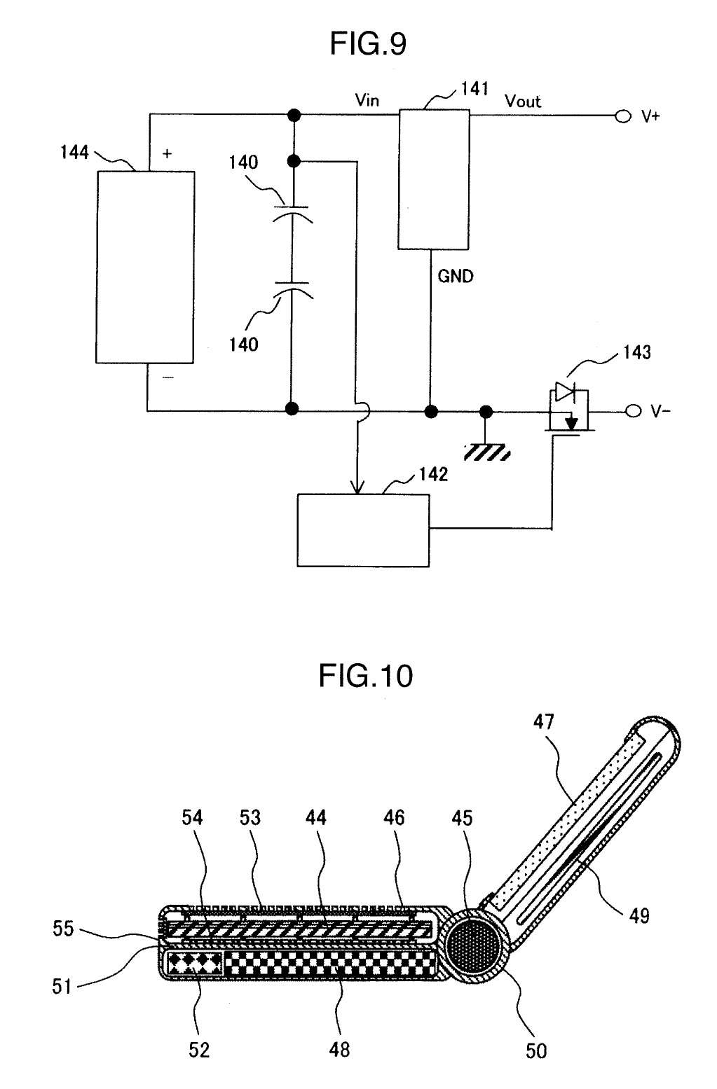

FIG. 9 illustrates one example of power system in which the fuel cell 144 is included, wherein 144: fuel cell, 140: electric double layer capacitor, 141: DC/DC converter, 142: means for judging/controlling on and off of load blocking switch 143. In this drawing, two electric double layer capacitors are connected in series. Power generated by the fuel cell 144 is temporarily stored in the electric double layer capacitor 140. The judgment/controlling means 142 measures quantity of power stored in the electric double layer capacitor, and switched on the load blocking switch 143, when it judges that a given quantity of power is stored, to supply power to an electronic equipment after it is increased in voltage by the DC/DC converter.

(3) Preparation of Portable Information Terminal

FIG. 10 illustrates one example of portable information terminal in which the fuel cell power system prepared in the step (2) above is mounted. The portable information terminal is equipped with the display 47 with which a touch-panel inputting device is integrated, segment with the built-in antenna 49, and fuel cell 44. The main board includes electronic equipment and circuits, e.g., processor, volatile and nonvolatile memories, power controller, fuel cell/secondary battery hybrid controller, and fuel monitor. It has a foldable structure with a segment including the main board, lithium-ion secondary battery and so forth is connected to a segment including the display and antenna by the hinge 50, which also works as a fuel cartridge holder.

The case in which the power source is mounted is divided into two segments by a diaphragm, the lower segment holding the main board 48 and lithium-ion secondary battery, and the upper segment holding the fuel cell power system. The slits 46 are provided on and sides of the case for diffusing air and cell off-gases. The air filter 57 is provided on the slits 46 in the case and water-absorbing, quick-drying material is provided on the diaphragm. The air filter material is not limited, so long as it well diffuses gases and rejects dust or the like. A mesh or fabric of single synthetic resin yarns is suitable, because it causes no clogging.

In Example 14, a mesh of single yarns of polytetrafluoroethylene, known for its water repellency, was used. The portable information terminal was continuously operable for 4,000 hours or more at a current density of 50 mA/cm² while producing an output voltage of 0.9 V.

The present invention exhibits proton conductivity for extended periods while keeping electron conductivity without blocking flow of fuel, oxygen or the like into the primary pores, by virtue of the proton conductivity providing group and hydrogen peroxide decomposing group introduced in the electron-conductive carbon. In other words, these groups allow the catalyst in the primary pores to effectively promote the cell reactions for extended periods. In particular, they allow the fuel cell, working at a low current density while producing smaller quantities of water on the cathode, to produce a high output for extended periods, and to improve maximum output density for extended periods. As a result, they help reduce size, weight and cost of the fuel cell, and also reduce catalyst requirement for the same output density.

The direct methanol fuel cell power system which uses the membrane electrode assembly, prepared in each of Examples, can be used as a battery charger mounted in a varying portable information terminal equipped with a secondary battery, e.g., cellular phone, personal computer, audio device or visual device. Moreover, it can be used as a built-in power source for an electronic equipment to save a secondary battery and hence to reduce size, weight and cost of the device.

Moreover, when fueled by hydrogen, the polymer electrolyte fuel cell with the membrane electrode assembly of the present invention may be used as a power source for dispersed power source systems for household and commercial purposes, and for moving objects to reduce size, weight and cost of the device in which it is incorporated. It can keep high utilization factor of catalyst held in primary pores for extended periods, and improve cell output for extended periods, when it works at a low current density, at which production of water on the cathode is suppressed. As a result, it can have a reduced size, weight and cost, and help reduce catalyst requirement for the same output density.

Water produced on the cathode, unless eliminated quickly, may cause the so-called flooding phenomenon, which is accompanied by oxygen shortage, to disrupt the continuous operation, and also cause other troubles, e.g., increased production of hydrogen peroxide on the catalyst to deteriorate the carbon support and electrolyte membrane. Introduction of a sulfonic acid or phosphonic acid group in the primary pores in the cathode makes the pores more hydrophilic and tends to hinder sufficient elimination of water produced. Therefore, it is preferable to impart water repellency to the carbon black provided with proton conductivity and working in the primary pores.

The method for imparting water repellency to the cathode-side carbon black in the primary pores, the carbon being provided with proton conductivity, is not limited. For example, it may exhibit water repellency in the primary pores, when treated with a fluorocompound having a perfluoropolyether chain and alkoxy silane residue, or having a fluoroalkyl group and alkoxy silane group. Of these fluorocompounds, the former is more preferable because it can make the carbon black more water-repellent. The fluorocompound having a fluoroalkyl group and alkoxy silane group is not limited, so long as it has both groups.

These fluorocompounds include perfluorooctyltrimethoxy silane, perfluorooctyltriethoxy silane, perfluorodecyltrimethoxy silane and perfluorodecyltriethoxy silane. The fluorocompounds having a perfluoropolyether chain and alkoxy silane residue include [F{CF(CF₃)—CF₂O}ₙ—CF(CF₃)]—X—Si(OR)₃, [F(CF₂CF₂CF₂O)ₙ]—X—Si(OR)₃, {H(CF₂)ₙ}—X—Si(OR)₃ and {F(CF₂)ₙ}—X—Si(OR)₃, wherein X is a site at which a perfluoropolyether chain and alkoxy silane residue are bonded to each other, Y is a site at which a perfluoroalkyl chain and alkoxy silane residue are bonded to each other, and R is an alkyl group. More specifically, they include perfluorooctylcarbamoylmethyltrimethoxy silane and perfluorooctylcarbamoylmethyltriethoxy silane.

### Examples 15 to 18

The Pt-supporting carbon black provided with a phosphonic and sulfonic acid groups, prepared in the step (2) in Examples 1 to 4, was immersed in a 0.1% by mass aqueous methanol solution of perfluorooctylcarbamoylmethyltrimethoxy silane for 24 hours, and filtered. It was then heated at 100° C. for 1 hour to make the carbon water-repellent in the primary pores. The carbon black is schematically illustrated in FIG. 2.

The same procedure as used in Examples 1 to 4 was repeated, except that the Pt-supporting carbon black provided with a phosphonic and sulfonic acid groups was replaced by the one treated to be water-repellent. The results are given in Table 4. As shown, the water-repellency treatment of the primary pores improved maximum output density.

TABLE 4

| | | Examples | | | |
|---|---|---|---|---|---|
| | | 15 | 16 | 17 | 18 |
| Carbon | Anhydrous aluminum chloride (g) | 15 | 10 | 7 | 5 |
| supporting | Thiophosphate chloride (mL) | 54 | 36 | 25 | 18 |
| Pt/Ru | Phosphonic acid content (meq/g) | 1.1 | 0.7 | 0.55 | 0.4 |
| | Sulfur trioxide gas concentration | 12 | 10 | 8 | 6 |
| | (% by volume) | | | | |
| | Reaction time (hours) | 2 | 2 | 3 | 4 |
| | Sulfonic acid group content (meq/g) | 1.8 | 1.5 | 1.3 | 1.2 |
| Carbon | Anhydrous aluminum chloride (g) | 15 | 10 | 7 | 5 |
| supporting | Thiophosphate chloride (mL) | 54 | 36 | 25 | 18 |
| Pt | Phosphonic acid content (meq/g) | 1.1 | 0.7 | 0.55 | 0.4 |
| | Sulfur trioxide gas concentration | 12 | 10 | 8 | 6 |
| | (% by volume) | | | | |
| | Reaction time (hours) | 2 | 2 | 3 | 4 |
| | Sulfonic acid group content (meq/g) | 1.8 | 1.5 | 1.3 | 1.2 |
| | Treatment with | Adopted | Adopted | Adopted | Adopted |
| | perfluorooctylcarbamoylmethyltrimethoxy | | | | |
| | silane | | | | |

| | | | | |
|---|---|---|---|---|
| Output voltage (V at 50 mA/cm²) | 0.99 | 0.8 | 0.7 | 0.65 |
| Maximum output density (mW/cm²) | 180 | 120 | 115 | 110 |
| Output voltage (V) of cell after working for 4000 hours | 0.99 | 0.79 | 0.69 | 0.64 |
| at a current density of 50 mA/cm² | | | | |

It should be further understood by those skilled in the art that although the foregoing description has been made on embodiments of the invention, the invention is not limited thereto and various changes and modifications may be made without departing from the spirit of the invention and the scope of the appended claims.

### ADVANTAGES OF THE INVENTION

The present invention can effectively utilize a catalyst in primary pores for extended periods, to sustain the effect of improving MEA output density or reducing catalyst requirement for extended periods, thus contributing to reduced fuel cell size and weight, reduced cost and extended serviceability.

1. A carbon support for fuel cell, incorporated with a proton-conductivity providing group and a hydrogen peroxide decomposing group on carbon particle surfaces.

2. The carbon support according to claim 1, wherein the proton-conductivity providing group and the hydrogen peroxide decomposing group are formed on the carbon particle surfaces and in carbon particle pores.

3. The carbon support according to claim 1, wherein a water-repellent film is provided on the carbon particle surfaces and in carbon particle pores.

4. The carbon support according to claim 1, wherein the hydrogen peroxide decomposing group is phosphonic acid group or a phosphoalkyl group.

5. The carbon support according to one of claims 1 to 3, wherein the hydrogen peroxide decomposing group is incorporated at 0.2 to 0.6 milliequivalents/g-dry carbon.

6. The carbon support according to one of claims 1 to 3, wherein the proton-conductivity providing group is sulfonic acid group or a sulfoalkyl group.

7. The carbon support according to one of claims 1 to 4, wherein the proton-conductivity providing group is incorporated at 0.4 to 1.8 milliequivalents/g-dry carbon.

8. An electrode material for fuel cell, comprising carbon which is incorporated with a proton-conductivity providing group and a hydrogen peroxide decomposing group on carbon particle surfaces, and supports a catalyst on the carbon particle surfaces.

9. An electrode material for fuel cell, comprising a polymer electrolyte and mixed with an electrode material comprising carbon which is incorporated with a proton-conductivity providing group and a hydrogen peroxide decomposing group on carbon particle surfaces, and supports a catalyst.

10. The electrode material according to claim 8 or 9, wherein a water-repellent film is provided on the carbon particle surfaces and in carbon particle pores.

11. The electrode material according to claim 8, which is a mixture of the electrode material and a polymer electrolyte.

12. A membrane electrode assembly comprising:
a polymer electrolyte membrane; and
an anode and cathode sandwiching the polymer electrolyte,
wherein each of the anode and cathode contains at least a carbon support, and an electrode catalyst and a polymer electrolyte supported on the carbon support, and wherein the carbon support is incorporated with a proton-conductivity providing group and a hydrogen peroxide decomposing group.

13. The membrane electrode assembly according to claim 12, wherein the catalyst is supported on carbon particle surfaces.

14. The membrane electrode assembly according to claim 12, wherein the catalyst is supported on carbon particle surfaces, and the carbon is mixed with the polymer electrolyte.

15. The membrane electrode assembly according to claim 12, wherein a water-repellent film is provided on carbon particle surfaces and in carbon particle pores.

16. The membrane electrode assembly according to claim 12, wherein the hydrogen peroxide decomposing group incorporated in the carbon support is a phosphonic acid group or a phosphoalkyl group.

17. The membrane electrode assembly according to claim 12, wherein the hydrogen peroxide decomposing group is incorporated in the carbon support at 0.2 to 0.6 milliequivalents/g-dry carbon.

18. The membrane electrode assembly according to claim 12, wherein the proton-conductivity providing group incorporated in the carbon support is sulfonic acid group or a sulfoalkyl group.

19. A fuel cell comprising:
a membrane electrode assembly having a polymer electrolyte membrane and an anode and cathode sandwiching the polymer electrolyte;
an anode-side diffusion layer provided on an outside of the anode;
a cathode-side diffusion layer provided on an outside of the cathode;
an anode-side current collector and an anode-side terminal plate provided on an outside of the anode-side diffusion layer; and
a cathode-side current collector and a cathode-side terminal plate provided on an outside of the cathode-side diffusion layer,
wherein each of the anode and cathode contains at least a carbon support, and an electrode catalyst and a polymer electrolyte supported on the carbon support, and the carbon support is incorporated with a proton-conductivity providing group and a hydrogen peroxide decomposing group.

20. The fuel cell according to claim 19 which is fueled by methanol.

21. The fuel cell according to claim 19, wherein a water-repellent film is provided on carbon particle surfaces and in carbon particle pores.

22. The fuel cell according to claim 19, wherein the anode is an air electrode and the cathode is a methanol fuel electrode.

23. The fuel cell according to claim 19, wherein the hydrogen peroxide decomposing group is a phosphonic acid group or a phosphoalkyl group.

24. The fuel cell according to claim 19, wherein the hydrogen peroxide decomposing group is incorporated at 0.2 to 0.6 milliequivalents/g-dry carbon.

25. The fuel cell according to claim 19, wherein the proton-conductivity providing group is a sulfonic acid group or a sulfoalkyl group.

26. A fuel cell power system equipped with the fuel cell according to claim 19, a power source controller and a DC/DC converter.

27. An electronic equipment including the fuel cell power system according to claim 26.

28. The electronic equipment according to claim 27 which is a portable information terminal, a portable notebook personal computer, a cellular phone or a camcorder.
